(19) United States
(12) Patent Application Publication
(10) Pub. No.: US 2010/0014715 A1
(43) Pub. Date: Jan. 21, 2010

(54) IMAGE PROCESSING APPARATUS HAVING TEXTURE INFORMATION CONSIDERATION AND METHOD THEREOF

(76) Inventors: Siou-Shen Lin, Taipei County (TW); Chin-Chuan Liang, Taichung City (TW); Te-Hao Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/174,639

(22) Filed: Jul. 17, 2008

(51) Int. Cl. G06K 9/46

(52) U.S. Cl. 382/108

(57) ABSTRACT

An image processing apparatus includes a block matching unit, a texture information analyzing unit, and a matching cost generating unit. The block matching unit compares at least a target block and at least a reference block to generate a matching result. The texture information analyzing unit generates a texture analysis result corresponding to texture information of the target block and texture information of the reference block. The matching cost generating unit is coupled to the block matching unit and the texture information generating unit, and generates a matching cost according to the matching result and the texture analysis result.

### BACKGROUND

The invention relates to an image processing apparatus and a method thereof and, more particularly, to an image processing apparatus for generating matching cost with texture consideration and a method thereof.

Nowadays, video information applied to various electronic devices has enriched our daily life. High quality video information having large data amounts, however, increases the level of the difficulty in processing, storage and transmission. Video compression is therefore needed for reducing the cost of transmitting or storing the video information. In video compression, one important technique is utilizing a motion vector to represent how an object shifts between successive frames. Consider a car moving across a silent field: after obtaining the information of the silent background, the information worth processing or transmission is the motion of the car rather than every entire frame.

In conventional methods, to recognize “the object” in successive frames, two successive frames are both partitioned into several blocks wherein each blocks contains several pixels (e.g., 8×8 pixels or 16×16 pixels). A reference block, “the object”, is selected from blocks of the previous frame, and a target block is selected from blocks of the instant frame. The difference between the target block and the reference block is measured between each pixel of the target block and the reference block. The measured difference represents the matching cost between the reference block and the target block. By selecting other blocks of the instant frame as new target frames and measuring each matching costs corrseponding to each new target frames, a target block having the lowest matching cost value is selected as the best matched block. The best matched motion vector, therefore, can be obtained as a shifting of the best matched block and the reference block. The above-mentioned image processing technique is also refered to as motion estimation.

However, in some applications, like tracking or frame rate conversion (FRC), etc., finding the “true motion” is more important than finding the best matched block. FIG. 1 is a diagram showing an interpolation error occurring when applying the conventional motion estimation. For determining the block 3ᵢ of the iterpolated frame, the matching cost MC1 corrresponding to the difference between the block 2ₙ₋₁ of the frame n−1 and block 4ₙ of the frame n, the matching cost MC2 corrresponding to the difference between the block 3ₙ₋₁ of the frame n−1 and block 4ₙ of the frame n, and the matching cost MC3 corrresponding to the difference between the block 4ₙ₋₁ of the frame n−1 and block 2ₙ of the frame n are compared. Referring to FIG. 1, an object labled with slash lines existing between block 4ₙ₋₁ and 3ₙ₋₁ of frame n−1 shifts to the middle of blocks 2ₙ and 3ₙ of frame n. The matching costs MC2 and MC3 will be higher than matching cost MC1, since blocks 2ₙ₋₁ and 4ₙ are both blank blocks, or the object labled with slash lines does not shift based on integral blocks. In the end, according to blocks 2ₙ₋₁ and 4ₙ, the block 3ᵢ of the interpolated frame is incorrectly determined to be a blank block. While successively displaying the frame n−1, the interpolated frame, and the frame n, the sudden disappearance of the object labeled with slash lines will lead to an uncomfortable twinkle for the viewer.

### SUMMARY

To overcome the above-mentioned problem, one objective of the invention is to provide an image processing apparatus with texture consideration and a method thereof in order to find the “true motion” of the object.

According to one exemplary embodiment of the present invention, an image processing apparatus is provided. The image processing apparatus comprises a block matching unit, a texture information analyzing unit, and a matching cost generating unit. The block matching unit compares at least a target block and at least a reference block to generate a matching result. The texture information analyzing unit generates a texture analysis result corresponding to texture information of the target block and texture information of the reference block. The matching cost generating unit is coupled to the block matching unit and the texture information generating unit, and generates a matching cost according to the matching result and the texture analysis result.

According to another exemplary embodiment, an image processing method employed by the above-mentioned image processing apparatus is provided. The image processing method comprises comparing at least a target block and at least a reference block to generate a matching result, generating a texture analysis result corresponding to texture information of the target block and texture information of the reference block, and generating a matching cost according to the matching result and the texture analysis result. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an interpolation error occurring when a conventional motion estimation is implemented.

FIG. 2 is a functional block diagram of an image processing apparatus according to an embodiment of the invention.

FIG. 3 is a flowchart showing an image processing method according to an embodiment of the invention.

FIG. 4 is a functional block diagram of another image processing apparatus according to one alternative embodiment of the invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

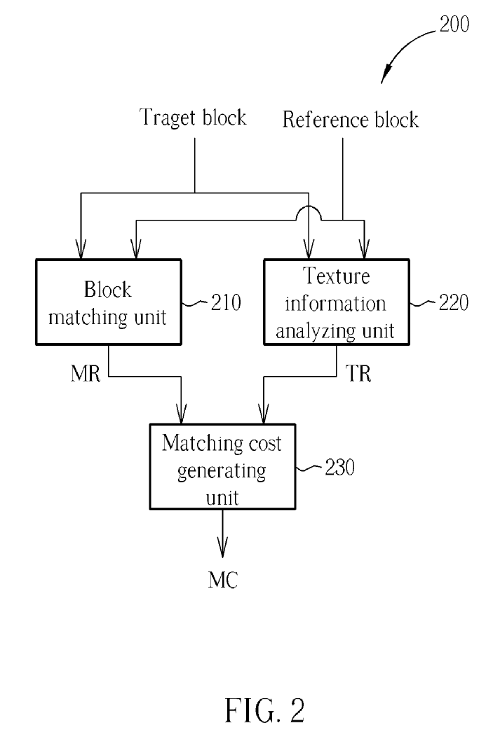

FIG. 2 is a functional block diagram of an image processing apparatus according to an embodiment of the invention. The image processing apparatus 200 comprises a block matching unit 210, a texture information analyzing unit 220 and a matching cost generating unit 230. The block matching unit 210 compares a target block and a reference block to generate a matching result. The target block and the reference block can be derived from different image frames or from the same image frame. The texture information analyzing unit 220 generates a texture analysis result corresponding to texture information of the target block and the reference block. The matching cost generating unit 230 is coupled to the block matching unit 210 and the texture information generating unit 220, and generates a matching cost according to the matching result and the texture analysis result. Please note that only the components related to the invention are shown in FIG. 2 for simplicity.

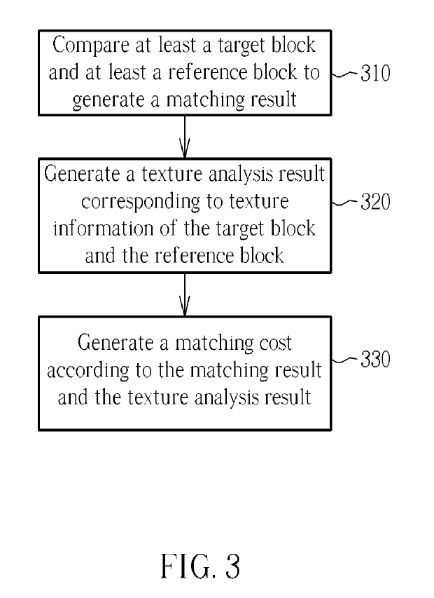

FIG. 3 is a flowchart showing an image processing method according to an embodiment of the invention. The steps for the method of FIG. 3 are as below:
Step 310: Compare at least a target block and at least a reference block to generate a matching result.
Step 320: Generate a texture analysis result corresponding to texture information of the target block and the reference block.
Step 330: Generate a matching cost according to the matching result and the texture analysis result.

The steps listed above can be performed in any order, and any of the included steps can be integrated, separated, or omitted so as to obtain substantially the same result and goal of the method. Any such manipulation of the steps above should be considered within the scope of the invention.

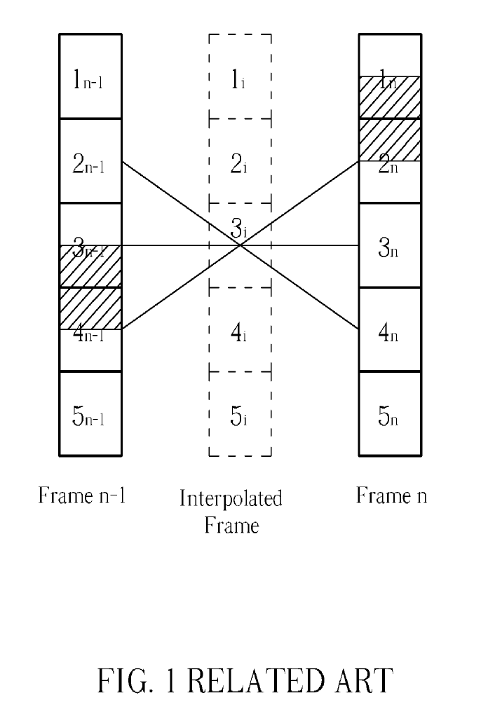

Please refer to FIG. 1 in conjunction with FIG. 2 and FIG. 3. According to Step 310, the block matching unit 210 compares a target block and a reference block to generate a matching result MR. In this embodiment, the target block is block 2ₙ of the frame n in FIG. 1, and the reference block is block 4ₙ₋₁ of the frame n−1 in FIG. 1. To find the difference between the two blocks, the block matching unit 210 compares block 2ₙ and block 4ₙ₋₁ by applying error prediction techniques, like the mean square error (MSE) technique, the sum of absolute difference (SAD) technique or sum of square difference (SSD) technique, etc. In general, the matching result generated by the block matching unit 210 is directly referred to as the matching cost of the two blocks, and is utilized in related image processing, such as generating a motion vector or determining an interpolated block. However, a matching cost simply considering differences of blocks may lead to problems, which must be modified by considering other important information.

One important piece of information is the edge information of a block. An edge indicates discontinuousness in terms of pixels, and implies that “an object” could be outlined by that edge. In other words, finding the edge is helpful towards finding the object and, in turn, the “true motion” of the object. In addition, other important information would include variance information and a frequency response of a block. The variance information indicates entropy or a complexity of a block. If the block has a higher entropy value or is more complex, this implies that the block might have some objects or some important information deserving to be processed. The variance information can be roughly defined as the absolute-sum of difference between nearby pixels making up the block, as shown in the following Equation (1). Or more precisely, the variance information can be defined as the square-sum of difference between each pixel and the pixel average, as in the following Equation (2). Either one can be employed by the present invention, depending on the design considerations.

$$\begin{matrix}VR = {\sum }_{j} {\sum }_{i} \vert {x}_{ij} - {x}_{( i - 1 ) ( j - 1 )} \vert & Equation ( 1 ) \\ VR = {\sum }_{j} {\sum }_{i} {( {x}_{ij} - {x}_{0} )}^{2} & Equation ( 2 )\end{matrix}$$

In Equations (1) and (2), xᵢⱼ indicates each pixel consisting the block. x₀ indicates an average value of pixels consisting the block. VR indicates the variance information.

Furthermore, the purpose of considering the frequency response is similar to that for the variance, which is also utilized to indicate the complexity of the block. The frequency response of the block discloses the percentage of each different frequency band from the information making up the block, such as high-band, middle-band and low-band information. The frequency response of the block can be derived from applying a Fourier transform to the block or from applying other transforms like Fourier-related transforms. If the frequency response discloses that the block consists of various frequency band information, this implies that the block has some important information deserving to be processed.

Under the teachings of the above disclosure, people skilled in the art can readily realize that to determine the matching cost corresponding to the blocks, not only the difference between the blocks has to be considered but also the content of the blocks. In other words, the texture information of the blocks has to be considered when determining the matching cost corresponding to the blocks. According to Step 320, the texture information analyzing unit 220 generates a texture analysis result TR corresponding to texture information of block 2ₙ and block 4ₙ₋₁. Certainly, the texture analysis result TR can comprise edge information, variance information, frequency response information, or any combination of those. The texture information analyzing unit 220 is implemented for determining the texture information of the blocks. In this embodiment, for example, the texture information analyzing unit 220 can be a prewitt filter or a soble filter for determining edge information of block 2ₙ and block 4ₙ₋₁. People skilled in the art can readily realize that the texture information analyzing unit 220 can be other units for determining the variance information or the frequency response of block 2ₙ and block 4ₙ₋₁.

After obtaining the matching result MR and the texture analysis result TR, the matching cost MC of block 2ₙ and block 4ₙ₋₁ can be determined from both of them. According to Step 330, the matching cost generating unit 230 generates a matching cost MC according to the matching result MR and the texture analysis result TR. A block having abundant contents should have a higher opportunity than blank or smooth blocks to be selected for determining the corresponding motion vector. The matching cost generating unit 230 can simply be implemented using a subtractor for subtracting the texture analysis result TR from the matching result MR to generate the matching cost MC, or can be implemented using other units for generating the matching cost MC by considering the influence of the texture analysis result TR. The generated matching cost MC can be utilized in different image processes, like generating a motion vector. It should be noted that using the matching costs generated from the image processing apparatus 200 shown in FIG. 2 to derive motion vectors merely serves as one exemplary application, and is not meant to be taken as a limitation of the scope of the present invention.

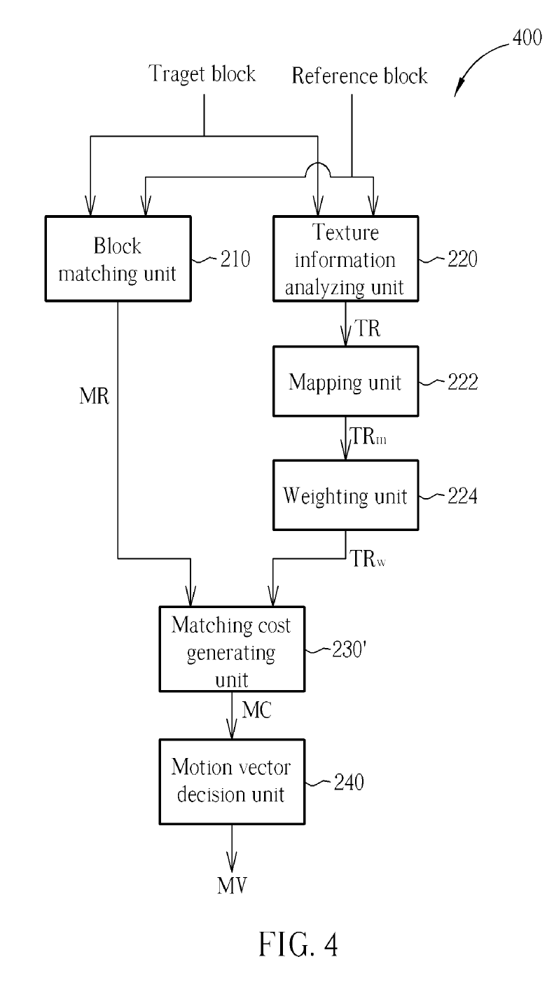

FIG. 4 is a functional block diagram of another image processing apparatus according to one alternative embodiment of the invention. The image processing apparatus 400 comprises a block matching unit 210, a texture information analyzing unit 220, a mapping unit 222, a weighting unit 224, a matching cost generating unit 230′ and a motion vector decision unit 240. The operations and functions of device components having the same name and reference numeral are identical to those in FIG. 2 and thus, their descriptions are omitted here for brevity. The mapping unit 222 is coupled to texture information analyzing unit 220, and maps the texture analysis result TR of a first bit length into a mapped texture analysis result TRₘ of a second bit length that is shorter than the first bit length. The weighting unit 224 is coupled to the mapping unit 222 and to the matching cost generating unit 230′, and adjusts the mapped texture analysis result TRₘ to generate a weighted texture analysis result TR_{w}. The matching cost generating unit 230′ is coupled to the block matching unit 210 and the weighting unit 224, and generates the matching cost MC according to the matching result MR generated by the block matching unit 210 and the weighted texture analysis result TR_{w}.

In this exemplary embodiment, the mapping unit 222 is used to simplify the computation complexity. For example, when the texture analysis result TR indicates that the edge information of block 2ₙ is higher than a predetermined value, the edge information of block 2ₙ is mapped to logic “1”, representing that an edge exists in block 2ₙ; and when the edge information of block 4ₙ₋₁ is lower than the predetermined value, the edge information of block 4ₙ₋₁ is mapped to logic “0”, representing that no edge exists in block 4ₙ₋₁. Table 1 illustrates the edge information as matrix form to generate the new Edge information according to a texture information analyzing unit 220 and a mapping unit 222.

TABLE 1
illustrating the example for edge information analyzing

Edge information

For n = 0 to N-1

For m = 0 to N-1

For y= 0 to 2

For x = 0 to 2

F (m, n) = F (m, n) + P (m-1 + x, n-1 + y) H(x, y)
G (m, n) = G (m, n) + C (m-1 + x, n-1 + y) H(x, y)

End

End

End

End

Edge bit map

if (F (m, n) > th)

EgP (m, n) = 1

else

EgP (m, n) = 0

if (G (m, n) > th)

EgC (m, n) = 1

else

EgC (m, n) = 0

$H = \frac{1}{3} [ \begin{matrix}1 & 0 & - 1 \\ 1 & 0 & - 1 \\ 1 & 0 & - 1\end{matrix} ] \qquad Prewitt$
$H = \frac{1}{4} [ \begin{matrix}1 & 0 & - 1 \\ 2 & 0 & - 2 \\ 1 & 0 & - 1\end{matrix} ] \qquad Sobel$

The weighting unit 224 is used to adjust the influence of the texture information, including the texture analysis result TR and the mapped texture analysis result TRₘ. The generated matching result MR and texture information can be generated based on different units of measurement. In addition, the texture information could have different meanings in different applications; for example, sometimes an edge is vital, and sometimes the edge can be omitted. The texture information, therefore, can be weighted into an appropriate amount. Please note that each piece of information comprised in the texture information (e.g., the edge information, the variance information and/or the frequency response of the target block or the reference block) can be weighted by different values independently.

The motion vector decision unit 240 can utilize the matching cost MC having texture consideration included therein to determine a corresponding motion vector. For example, the matching cost MC1′ corrresponding to block 2ₙ₋₁ of frame n−1 and block 4ₙ of frame n, the matching cost MC2′ corrresponding to block 3ₙ₋₁ of frame n−1 and block 4ₙ of frame n, and the matching cost MC3′ corrresponding to block 4ₙ₋₁ of frame n−1 and block 2ₙ of frame n are obtained as the above embodiments. The matching cost MC2′ will have a higher value compared to MC1′ and MC3′, since the difference between block 3ₙ₋₁ and block 3ₙ is bigger. The matching cost MC3′ is lower than the matching cost MC1′ since blocks 4ₙ₋₁ and 2ₙ have more abudant texture information than the blocks 2ₙ₋₁ and 4ₙ have. The motion vector decision unit 240 determines a motion vector consisting of a pair of bidirectional motion vectors directing from block 3ₙ to blocks 4ₙ₋₁ and 2ₙ, respectively, for the interpolated block 3ᵢ according to the matching cost MC3′. In this way, the interpolated block 3ᵢ is no longer incorrectly determined as a blank block. The twinkle phenomenon, therefore, can be solved. Please note that any unit(s) of the mapping unit 222, the weighting unit 224, and the motion vector decision unit 240 can be omitted, depending on different application requirements. In other words, any image processing devices having texture information involved in determining a matching cost fall in the scope of the invention.

To conclude, the apparatus and method provided by the embodiments of the invention generate the matching cost having texture information consideration, which is helpful for finding a “true motion” of an object, and especially helpful in the FRC or tracking application.

Those skilled in the art will readily observe that numerous modifications and alterations of the device and method may be made while retaining the teachings of the invention.

What is claimed is:

1. An image processing apparatus, comprising:
a block matching unit, for comparing at least a target block and at least a reference block to generate a matching result;
a texture information analyzing unit, for generating a texture analysis result corresponding to texture information of the target block and texture information of the reference block; and
a matching cost generating unit, coupled to the block matching unit and the texture information generating unit, for generating a matching cost according to the matching result and the texture analysis result.

2. The apparatus of claim 1, further comprising:
a weighting unit, coupled between the texture information analyzing unit and the matching cost generating unit, for adjusting the texture analysis result to generate a weighted texture analysis result;
wherein the matching cost correcting unit generates the matching cost according to the matching result and the weighted texture analysis result.

3. The apparatus of claim 1, further comprising:
a mapping unit, coupled between the texture information analyzing unit and the matching cost generating unit, for mapping the texture analysis result of a first bit length into a mapped texture analysis result of a second bit length, the second bit length being shorter than the first bit length;
wherein the matching cost correcting unit generates the matching cost according to the matching result and the mapped texture analysis result.

4. The apparatus of claim 3, wherein the texture analysis result includes reference texture information of the reference block and target texture information of the target block, the mapped texture analysis result includes reference one-bit information corresponding to the reference texture information and target one-bit information corresponding to the target texture information.

5. The apparatus of claim 3 further comprising:
a weighting unit, coupled between the mapping unit and the matching cost generating unit, for adjusting the mapped texture analysis result to generate a weighted texture analysis result;
wherein the matching cost correcting unit generates the matching cost according to the matching result and the weighted texture analysis result.

6. The apparatus of claim 1, wherein the texture information is selected from a group consisting of an edge information, a variance information, and a frequency response information.

7. The apparatus of claim 1, wherein the target block and the reference block are derived from different image frames.

8. The apparatus of claim 1, wherein the block matching unit compares a plurality of target blocks and a plurality of reference blocks to generate a plurality of matching results respectively; the texture information analyzing unit generates a plurality of texture analysis results according to the target blocks and the reference blocks; the matching cost generating unit generates a plurality of matching costs according to the matching results and the texture analysis results; and the apparatus further comprises:
a motion vector decision unit, coupled to the matching cost generating unit, for determining a motion vector of an interpolated block according to the matching costs.

9. An image processing method, comprising:
comparing at least a target block and at least a reference block to generate a matching result;
generating a texture analysis result corresponding to texture information of the target block and texture information of the reference block; and
generating a matching cost according to the matching result and the texture analysis result.

10. The method of claim 9, further comprising:
adjusting the texture analysis result to generate a weighted texture analysis result;
wherein the matching cost is generated according to the matching result and the weighted texture analysis result.

11. The method of claim 9, further comprising:
mapping the texture analysis result of a first bit length into a mapped texture analysis result of a second bit length, the second bit length being shorter than the first bit length;
wherein the matching cost is generated according to the matching result and the mapped texture analysis result.

12. The method of claim 11, wherein the texture analysis result includes reference texture information of the reference block and target texture information of the target block, the mapped texture analysis result includes reference one-bit information corresponding to the reference texture information and target one-bit information corresponding to the target texture information.

13. The method of claim 11 further comprising:
adjusting the mapped texture analysis result to generate a weighted texture analysis result;
wherein the matching cost is generated according to the matching result and the weighted texture analysis result.

14. The method of claim 9, wherein the texture information is selected from a group consisting of edge information, variance information, and frequency response information.

15. The method of claim 9, wherein the target block and the reference block are derived from different image frames.

16. The method of claim 9, further comprising:
comparing a plurality of target blocks and a plurality of reference blocks to generate a plurality of matching results respectively;
generating a plurality of texture analysis results according to the target blocks and the reference blocks;
generating a plurality of matching costs according to the matching results and the texture analysis results; and
determining a motion vector of an interpolated block according to the matching costs.
